(19) United States
(12) Patent Application Publication
(10) Pub. No.: US 2022/0104608 A1
(43) Pub. Date: Apr. 7, 2022

(54) Multi-Tool Case

(71) Applicant: Smith's Consumer Products, Inc., Hot Springs, AR (US)

(72) Inventor: Louis Chalfant, Hot Springs, AR (US)

(21) Appl. No.: 17/064,113

(22) Filed: Oct. 6, 2020

(51) Int. Cl. A45F 5/02

(52) U.S. Cl. CPC A45F 5/021; A45F 2200/0575

(57) ABSTRACT

A tool case for attaching to a belt for storing a multi-tool having an open (or unfolded) position and a closed (or folded) position. The tool case includes a front portion and a back portion. A compartment is formed between the front portion and the back portion and is configured to receive and retain a multi-tool in both the open position and the closed position.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

A multi-tool is a tool with multiple tool components, typically including pliers, screwdrivers, and knives. Because a multi-tool is commonly stored in toolbox and available space in the toolbox is limited, when the pliers of the multi-tool are not in use, the pliers are folded between the handles of the multi-tool to make the multi-tool more compact. The next time the owner of the multi-tool needs to use the pliers, the multi-tool must be located in the toolbox and the pliers must be unfolded. This repetitive step of locating the multi-tool, unfolding the pliers, using the pliers, folding the pliers, and placing the multi-tool back in the tool box is time consuming and inconvenient. It would therefore be desirable to develop a tool case for attaching to a belt that is capable of storing a multi-tool both in the unfolded (or open) and the folded (or closed) positions.

### BRIEF SUMMARY OF THE INVENTION

The present invention is directed to a tool case for attaching to a belt for storing a multi-tool both in the open position and the closed position. The tool case includes a front portion and a back portion, which may be separate interlocking pieces. A compartment is formed between the front portion and the back portion of the case and is configured to receive and retain the multi-tool in both the open position and the closed position.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1A is a perspective view of the outer surface of the back piece of the tool case of the present invention with the belt clip omitted.

FIG. 1B is a perspective view of the outer surface of the back piece of the tool case of the present invention.

FIG. 2 is a perspective view of the inner surface of the back piece of the tool case of the present invention.

FIG. 3 is a side view of the inner surface of the back piece of the tool case of the present invention.

FIG. 4 is a perspective view of the front piece of the tool case of the present invention.

FIG. 5 is a perspective view of the front piece of the tool case of the present invention.

FIG. 6 is a perspective view of the front piece of the tool case of the present invention.

FIG. 7 is a side view of the tool case of the present invention.

FIG. 8 is a top view of the tool case of the present invention.

FIG. 9 is a top view of the tool case of the present invention.

FIG. 10 is a back view of the tool case of the present invention.

FIG. 11 is a front view of the tool case of the present invention.

FIG. 12 is a perspective view of a multi-tool in the open position that may be inserted into the tool case of the present invention.

FIG. 13 is a perspective view of a multi-tool in the closed position that may be inserted into the tool case of the present invention.

FIG. 14 is a side view of the tool case of the present invention holding a multi-tool in the closed position.

FIG. 15 is a perspective view of the tool case of the present invention holding a multi-tool in the closed position.

FIG. 16 is a perspective view of the tool case of the present invention holding a multi-tool in the open position.

FIG. 17 is a perspective view of the tool case of the present invention holding a multi-tool in the open position.

FIG. 18 is a perspective view of the tool case of the present invention holding a multi-tool in the open position.

### DETAILED DESCRIPTION OF THE INVENTION

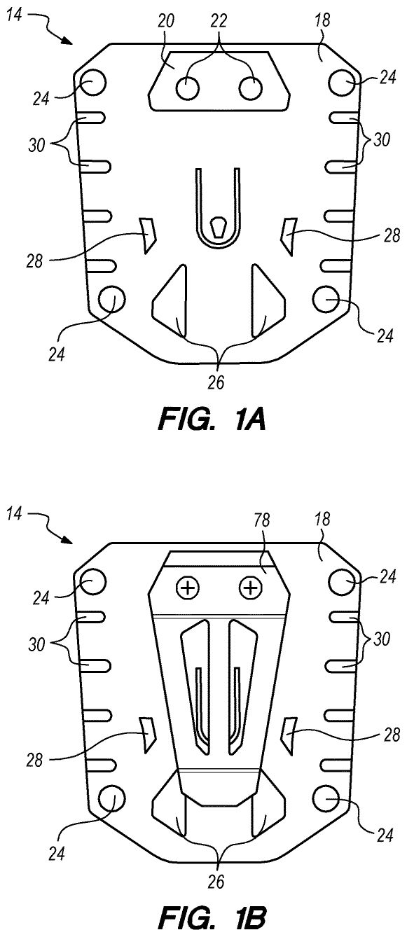

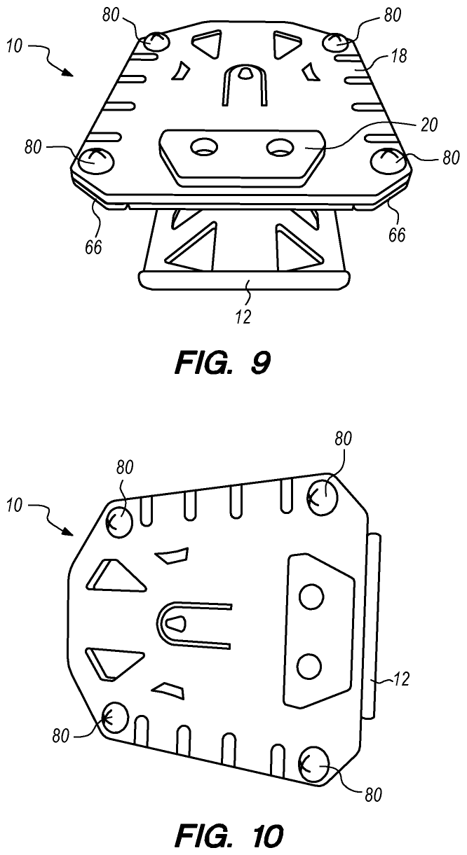

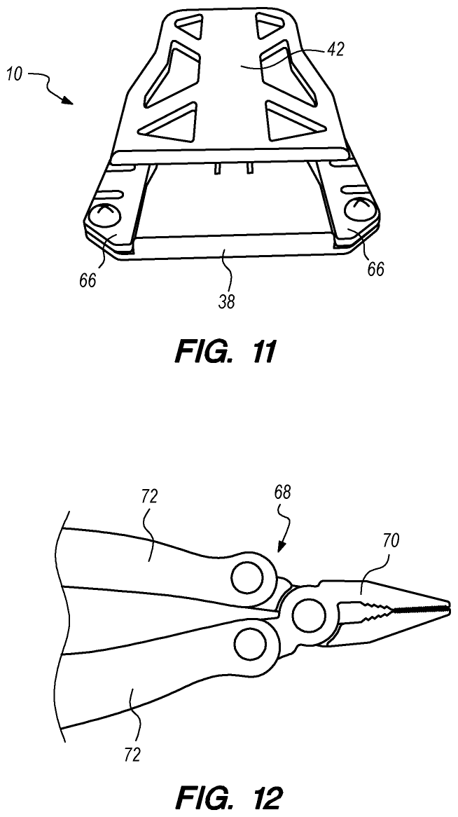

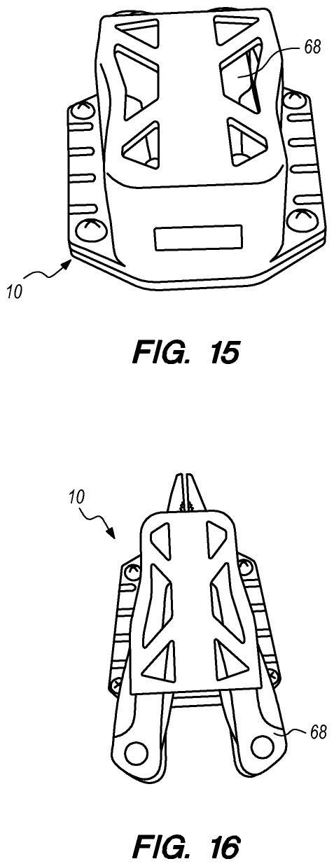

With reference to FIGS. 1A-18, the preferred embodiments of the present invention may be described. The present invention is directed to a tool case 10 for a multi-tool. The tool case 10 preferably includes a front portion and a back portion. In one embodiment, the tool case 10 preferably includes two interlocking pieces: front piece 12 and back piece 14. The back piece 14 is preferably eight-sided, as shown in FIGS. 1A-3. The back piece 14 preferably includes a top surface, two side surfaces, a bottom surface, and four angled corners. The back piece 14 includes four holes 24 in the corners of the back piece 14 for the back piece 14 and the front piece 12 to be fastened together with fasteners 80. These holes 24 extend through the back piece 14. The back piece 14 includes an inner surface 16 and an outer surface 18. As shown in FIG. 1A, the outer surface 18 of the back piece 14 includes a plate 20 positioned along the top surface. There are preferably two holes 22 that extend through the plate 20. The two holes 22 do not extend through the back surface 18 of the back piece 14. The holes 22 are used to fasten a belt clip 78 to the plate 20 attached to the back piece 14, as shown in FIG. 1B. The back piece 14 includes cutouts 26, 28 for aesthetic purposes. Spaced indentions 30 line opposite sides of the back piece 14.

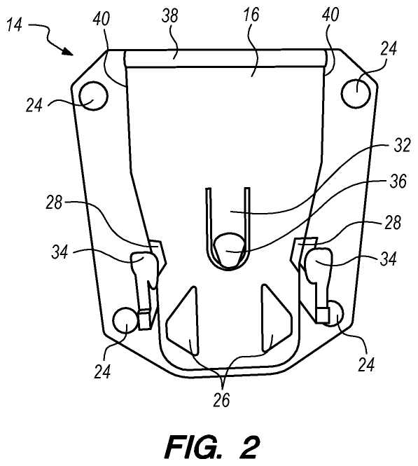

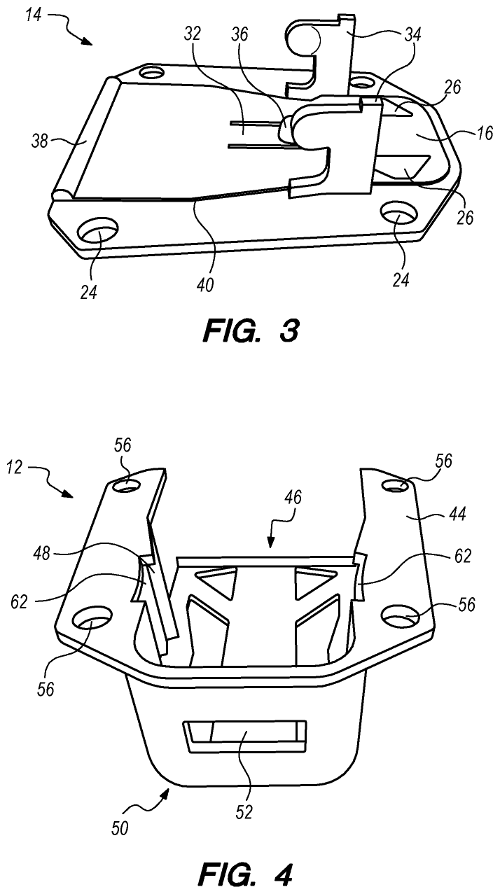

The inner surface 16 of the back piece 14 of the tool case 10 is shown in FIGS. 2-3. A prong 32 is roughly centered in the back piece 14. A protrusion 36 is positioned at the free end of the prong 32. The inner surface 16 of the back piece 14 also includes two L-shaped arms 34 spaced from one another, as shown in FIG. 3. The top of the inner surface 16 of the back piece 14 includes a rounded lip 38. As shown in FIGS. 2-3, a ridge 40 extends from one end of the lip along the left side, across the bottom, along the right side, and terminates at the opposite end of the lip 38. In this regard, the middle portion of the inner surface 16 of the back piece 14 is slightly elevated and the sides and bottom of the inner surface 16 of the back piece 14 are slightly recessed. The arms 34 are preferably positioned adjacent the ridge 40 on both the left and right sides of the inner surface 16 of the back piece 14.

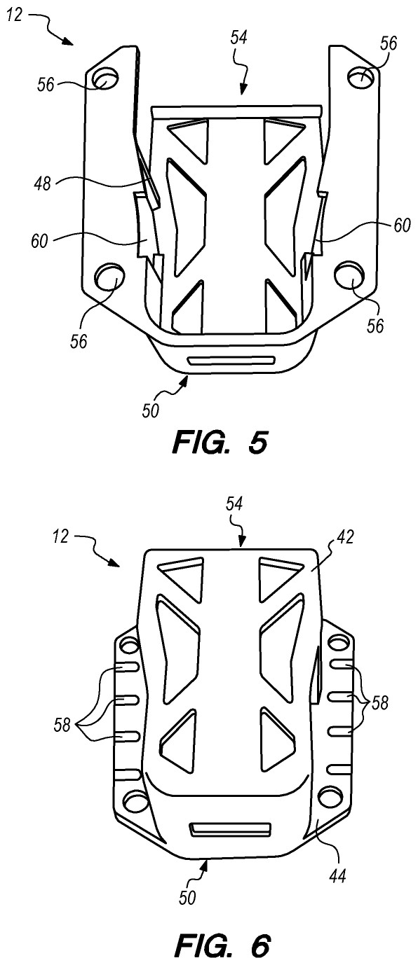

The front piece 12 of the tool case 10 includes a front plate 42 joined to a back plate 44 to create an internal compartment 46 between the front plate 42 and the back plate 44, as shown in FIGS. 4-6. The front plate 42 and the back plate 44 are joined by two supports 48 positioned between the ends of the front plate 42 and back plate 44. The front plate 42 and the back plate 44 are also joined at the closed end 50 of the front piece. Spaces 60 are created on opposite sides of the front piece 12 between the front plate on top, the back plate on bottom, the closed end 50 on one end, and the supports 48 on the opposite end, as shown in FIG. 5. The closed end includes a rectangular slot 52. The front plate 42 is wider at the open end 54 of the front piece 12 than the closed end 50 of the front piece 12. The back plate 44 of the front piece 12 includes four holes 56 that extend through the back plate. The holes 56 are preferably positioned in the four corners of the back plate 44. The distance between the holes 56 positioned towards the open end 54 of the front piece 12 is greater than the distance between the holes 56 at the closed end 50 of the front piece 12. A series of indentions 58 are positioned on the left and right sides of the back plate 44 of the front piece 12. When the front piece 12 and the back piece 14 are fastened together, the indentions 58 of the front piece 12 mirror the indentions 30 of the back piece 14. The back plate 44 includes two notches 62 between the closed end 50 of the front piece 12 and the two supports 48, as shown in FIG. 4.

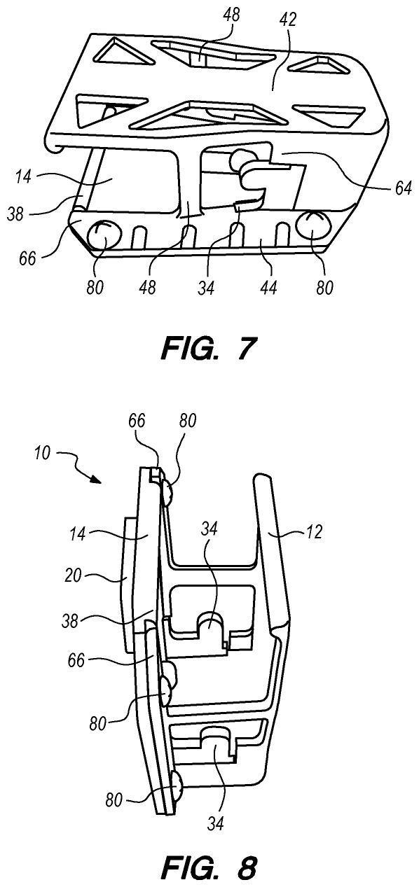

The front piece 12 and the back piece 14 are preferably interlockable, as shown in FIGS. 7-11 and 14-18. The bottom surface of the back plate 44 of the front piece 12 rests on the recessed portion of the inner surface of the back piece 14, as shown in FIG. 7. When in this position, the holes 24 in the back piece 14 are aligned with the holes 56 in the front piece. A fastener 80 extends through the holes 24, 56 to fasten the front piece 12 and back piece 14 together. As shown in FIG. 7, the arms 34 are positioned in the spaces 60 of the front piece 12, with the two notches of the back plate 44 receiving the base of the arms 34 and the top of the arms 34 contacting the bottom surface of an undercut 64 in the closed end 50 of the front piece 12. In addition, the free end 66 of the back plate 44 of the front piece 12 preferably rests flush against the lip 38 of the back piece 14, as shown in FIG. 7.

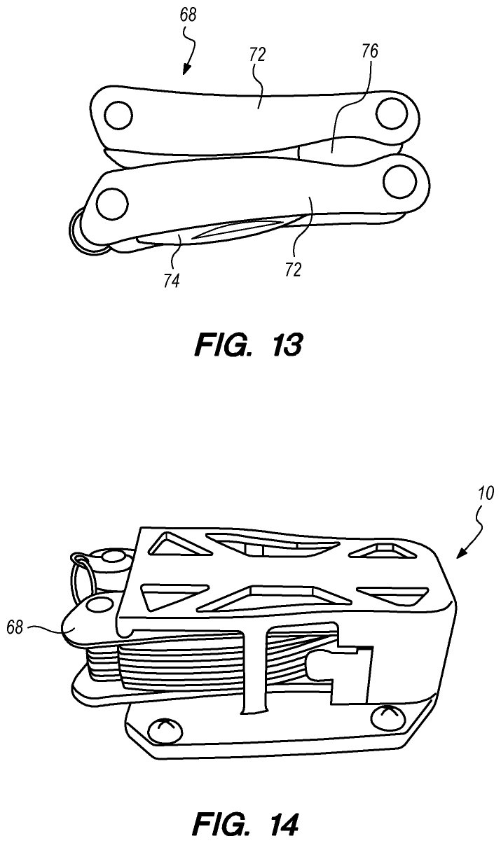

When the front piece 12 and the back piece 14 are interlocked, the tool case 10 is configured to receive and hold a multi-tool 68. The multi-tool 68 has an open position and a closed position. In the open position, as shown in FIG. 12, the head 70 of the pliers of the multi-tool is exposed. In the closed position, the head 70 of the pliers of the multi-tool 68 is folded between the handles 72 of the pliers. The multi-tool also preferably includes a variety of knives 74 and other accessories that are stored in the handles 72 of the pliers. As shown in FIG. 13, when the multi-tool 68 is in the closed position, a portion of head 70 of the pliers is exposed in a space 76 between the handles 72. In addition, one end of the tool case 10 is narrower than the opposite end of the tool case 10 when the tool case is in the closed position.

The tool case 10 has an open end and a closed end. The narrow end of the multi-tool 68 in the closed position may be inserted into the open end of the tool case 10 and slid to the closed end of the tool case 10, as shown in FIG. 14. The multi-tool 68 is slid into the tool case 10 such that the protrusion 36 attached to the back piece 14 is positioned in the space 76 between the handles 72 of the multi-tool when in the closed position. The protrusion 36 positioned in the space 76 retains the multi-tool 68 in the tool case 10. In this regard, the protrusion 36 attached to the prong 32 serves as a detent.

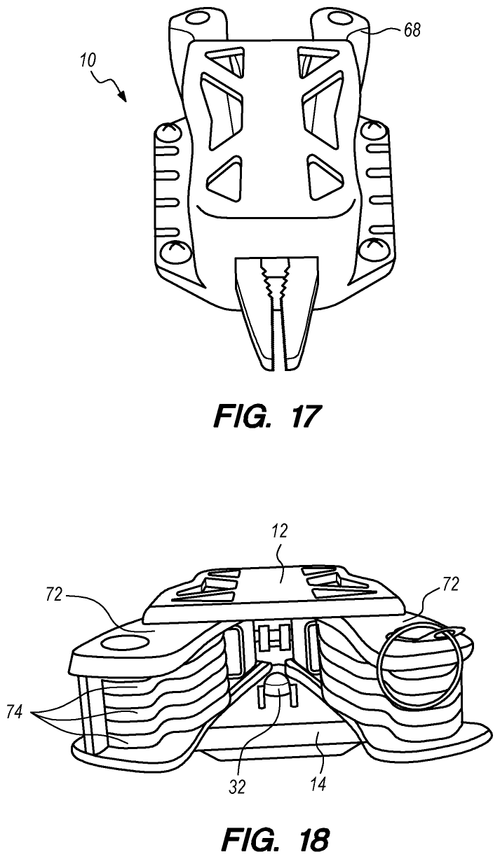

The multi-tool 68 may also be inserted into the open end of the tool case 10 when the multi-tool is in the open position. The head of the pliers 70 of the multi-tool 68 is slid into the tool case 10 until the head of the pliers 70 passes through the slot 52 in the closed end 50 of the tool case, as shown in FIGS. 16-17. The handles 72 of the pliers are connected to the head 70 at an angle. As shown in FIG. 18, the inside surfaces of the handles 72 contact the protrusion 36, which retains the multi-tool 68 in the tool case 10. Thus, the protrusion 36 attached to the prong 32 serves as a detent whether the multi-tool is in the closed position or the open position.

The multi-tool 68 may be removed from the tool case 10, whether the multi-tool 68 is in the closed position or open position, by pulling the multi-tool 68 through the open end of the tool case 10. It should be understood that the tool case of the present invention may be configured to receive and hold any multi-tool having open and closed positions that would be well-known to a person of ordinary skill in the art.

In an alternative embodiment, the front piece 12 and the back piece 14 are a single piece instead of two separate pieces.

The present invention has been described with reference to certain preferred and alternative embodiments that are intended to be exemplary only and not limiting to the full scope of the present invention as set forth in the appended claims.

1. A case for a multi-tool, said multi-tool having an unfolded position and a folded position, wherein said case comprises:
a front portion and a back portion; and
a compartment formed between said front portion and said back portion, wherein said compartment is configured to receive said multi-tool when said multi-tool is in said unfolded position and in said folded position, wherein an end of said case comprises a slot, wherein said slot permits passage of a first portion of said multi-tool through said slot but prevents passage of a second portion of said multi-tool through said slot.

2. The case of claim 1, wherein said front portion is a first separate piece and said back portion is a second separate piece.

3. The case of claim 2, wherein said front piece and said back piece are interlockable.

4. The case of claim 1, wherein said back portion comprises a detent for retaining said multi-tool in said compartment.

5. The case of claim 4, wherein said detent comprises a protrusion attached to a prong.

6. The case of claim 1, further comprising a belt clip.

7-8. (canceled)

9. The case of claim 1, wherein said case is tapered towards said slot.

10. The case of claim 1, wherein said slot extends less than a width of said end and less than a height of said end.
